(19) United States
(12) Patent Application Publication
(10) Pub. No.: US 2026/0360326 A1
(43) Pub. Date: Nov. 12, 2026

(54) LIQUID CRYSTAL DISPLAY APPARATUSES

(71) Applicants: Beijing BOE Technology Development Co., Ltd., Beijing (CN); BOE Technology Group Co., Ltd., Beijing (CN)

(72) Inventors: Xiangjun PENG, Beijing (CN); Qiong WU, Beijing (CN); Longhui WANG, Beijing (CN); Huiling XUE, Beijing (CN); Shuo ZHANG, Beijing (CN); Yifan HOU, Beijing (CN); Xin DUAN, Beijing (CN); Ce NING, Beijing (CN); Lizhong WANG, Beijing (CN); Hui GUO, Beijing (CN)

(21) Appl. No.: 19/488,510

(22) PCT Filed: Apr. 26, 2024
(86) PCT No.: PCT/CN2024/090067

§ 371 Date: Nov. 26, 2025

(30) Foreign Application Priority Data
May 31, 2023 (CN) 202310639498.5

(51) Int. Cl. G09G 3/36

(52) U.S. Cl. CPC G09G 3/3607; G09G 2320/0666; G09G 2340/06

(57) ABSTRACT

Provided is a liquid crystal display apparatus. The liquid crystal display apparatus includes a liquid crystal display panel and a control circuit, wherein the liquid crystal display panel includes a plurality of pixels; the control circuit has a first operating mode, and is configured, in the first operating mode, to: receive initial color information of each of the plurality of pixels of an m-th frame of image, and control, based on the initial color information, the liquid crystal display panel to sequentially display subfield images of n different hues, such that the m-th frame of image is acquired, wherein m and n are positive integers, n≥2, and the initial color information of each of the plurality of pixels includes initial gray levels under the n hues.

### CROSS-REFERENCE TO RELATED APPLICATION

The present disclosure is a U.S. national stage of international application No. PCT/CN2024/090067, filed on Apr. 26, 2024, which claims priority to Chinese Patent Application No. 202310639498.5, filed on May 31, 2023, and entitled “LIQUID CRYSTAL DISPLAY DEVICE, IMAGE DISPLAY METHOD, AND ELECTRONIC APPARATUS”, the entire contents of which are incorporated herein by references in their entireties.

### TECHNICAL FIELD

The present disclosure relates to the field of display technologies, and in particular, relates to liquid crystal display apparatuses.

### BACKGROUND

Display panels are an indispensable part of electronic devices such as televisions and mobile phones. Liquid crystal display panels are more widely used.

### SUMMARY

An objective of the present disclosure is to provide liquid crystal display apparatuses.

According to some embodiments of the present disclosure, a liquid crystal display apparatus is provided. The liquid crystal display apparatus includes a liquid crystal display panel and a control circuit, wherein the liquid crystal display panel includes a plurality of pixels;
the control circuit has a first operating mode, and is configured, in the first operating mode, to: receive initial color information of each of the plurality of pixels of an m-th frame of image, and control, based on the initial color information, the liquid crystal display panel to sequentially display subfield images of n different hues, such that the m-th frame of image is acquired, wherein m and n are positive integers, n≥2, and the initial color information of each of the plurality of pixels includes initial gray levels under the n hues; and
in the m-th frame of image, actual color information of each of the plurality of pixels includes actual gray levels under the n hues; and at least part of the plurality of pixels are target pixels, wherein a color reflected by the actual color information of each of the target pixels is different from a color reflected by the initial color information, and a difference among the actual gray levels of the same target pixel is greater than a difference among the initial gray levels of the same target pixel.

In some exemplary embodiments of the present disclosure, in a YUV color space, a hue angle of the color reflected by the initial color information is an initial hue angle, and a hue angle of the color reflected by the actual color information is an actual hue angle; and hue angles of n reference colors are reference hue angles; and
in the YUV color space, a difference between the initial hue angle and a reference hue angle closest to the initial hue angle is an initial angle; a difference between the reference hue angle closest to the initial hue angle and the actual hue angle is an actual angle; the initial angle of the same target pixel is greater than the actual angle.

In some exemplary embodiments of the present disclosure, in the YUV color space, the initial hue angle and the actual hue angle of the same target pixel satisfy:

$$[ \begin{matrix}{U}_{t}^{′} \\ {V}_{t}^{′}\end{matrix} ] = [ \begin{matrix}sin Δθ & cos Δ θ \\ cos Δ θ & - sin Δ θ\end{matrix} ] \cdot [ \begin{matrix}{U}_{t} \\ {V}_{t}\end{matrix} ] ;$$

wherein Ut and Vt represent coordinates of the color reflected by the initial color information, and Ut′ and Vt′ represent coordinates of the color reflected by the actual color information, and Δθ represents a conversion angle, the conversion angle being a difference between the initial hue angle and the actual hue angle.

In some exemplary embodiments of the present disclosure, the initial angle is positively correlated with the conversion angle.

In some exemplary embodiments of the present disclosure, the actual color information of each of the plurality of pixels is determined based on the initial color information of the each of the plurality of pixels, and the control circuit is configured, in the first operating mode, to control, based on the actual color information, the liquid crystal display panel to sequentially display subfield images of the n hues, such that the m-th frame of image is acquired.

According to some embodiments of the present disclosure, a liquid crystal display apparatus is provided. The liquid crystal display apparatus includes a liquid crystal display panel and a control circuit, wherein the liquid crystal display panel includes a plurality of pixels;
the control circuit has a first operating mode, and is configured, in the first operating mode, to: receive initial color information of each of the plurality of pixels of an m-th frame of image, and control, based on the initial color information, the liquid crystal display panel to sequentially display subfield images of n different hues, such that the m-th frame of image is acquired, wherein m and n are positive integers, n≥2, and the initial color information of each of the plurality of pixels includes initial gray levels under the n hues; and
in the m-th frame of image, actual color information of each of the plurality of pixels includes actual gray levels under the n hues; and at least part of the plurality of pixels are target pixels, wherein luminance of a color reflected by the actual color information of the same target pixel is less than luminance of a color reflected by the initial color information of the same target pixel.

In some exemplary embodiments of the present disclosure, in a YUV color space, a hue angle of the color reflected by the initial color information is an initial hue angle, and a hue angle of the color reflected by the actual color information is an actual hue angle; hue angles of n reference colors are reference hue angles; and for a same hue of the same target pixel, a ratio of the initial gray level to the actual gray level is a reduction coefficient.

In the YUV color space, a difference between the initial hue angle and a reference hue angle closest to the initial hue angle is an initial angle, and the initial angle of the same target pixel is positively correlated with the reduction coefficient.

In some exemplary embodiments of the present disclosure, the actual color information of each of the plurality of pixels is determined based on the initial color information of the each of the plurality of pixels, and the control circuit is configured, in the first operating mode, to control, based on the actual color information, the liquid crystal display panel to sequentially display subfield images of the n hues, such that the m-th frame of image is acquired.

According to some embodiments of the present disclosure, a liquid crystal display apparatus is provided. The liquid crystal display apparatus includes a liquid crystal display panel and a control circuit, wherein the liquid crystal display panel includes a plurality of pixels;
the control circuit has a first operating mode, and is configured, in the first operating mode, to: receive initial color information of each of the plurality of pixels of an m-th frame of image, and control, based on the initial color information, the liquid crystal display panel to sequentially display subfield images of n different hues, such that the m-th frame of image is acquired, wherein m and n are positive integers, n≥2, and the initial color information of each of the plurality of pixels includes initial gray levels under the n hues; and
in the m-th frame of image, actual color information of each of the plurality of pixels includes actual gray levels under the n hues; and at least part of the pixels are target pixels, wherein the target pixels includes a first target pixel and a second target pixel; luminance reflecting the initial color information of the first target pixel is greater than a luminance threshold, and luminance reflecting the initial color information of the second target pixel is less than the luminance threshold; for a same hue of the same first target pixel, the actual gray level is less than the initial gray level, and for a same hue of the same second target pixel, the actual gray level is greater than the initial gray level.

In some exemplary embodiments of the present disclosure, in a YUV color space, a ratio of a color reflected by the actual color information of the first target pixel to coordinates reflecting the initial color information of the first target pixel is a first adjustment coefficient, and a ratio of luminance reflecting the actual color information of the second target pixel to the luminance reflecting the initial color information of the first target pixel is the first adjustment coefficient; and
a ratio of a color reflected by the actual color information of the second target pixel to coordinates reflecting the initial color information of the second target pixel is a second adjustment coefficient, and a ratio of the luminance reflecting the actual color information of the second target pixel to the luminance reflecting the initial color information of the second target pixel is the second adjustment coefficient; and
wherein the second adjustment coefficient is greater than the first adjustment coefficient.

In some exemplary embodiments of the present disclosure, both the first adjustment coefficient and the second adjustment coefficient are negatively correlated with luminance reflecting the actual color information of the target pixel.

In some exemplary embodiments of the present disclosure, the first adjustment coefficient is greater than 0 and less than 1, and the second adjustment coefficient is greater than 1; and the control circuit is configured, in the first operating mode, to control, based on the actual color information, the liquid crystal display panel to sequentially display subfield images of the n hues, such that the m-th frame of image is acquired.

In some exemplary embodiments of the present disclosure, the control circuit further has a second operating mode, and is configured, in the second operating mode, to: control, in receiving the initial color information of the m-th frame of image, the liquid crystal display apparatus to sequentially display n subfield images, such that the m-th frame of image is acquired, wherein

In the second operating mode, the actual gray level of each of the plurality of pixels is the initial gray level of the each of the plurality of pixels.

In some exemplary embodiments of the present disclosure, the liquid crystal display panel includes:
an array substrate and an opposing substrate that are opposite to each other; and
a liquid crystal layer disposed between the array substrate and the opposing substrate;
wherein the liquid crystal display apparatus further includes:
a backlight module disposed on a side, distal from the opposing substrate, of the array substrate and including light-emitting components of n different colors, wherein the backlight module emits light of a same color when displaying a same subfield image and emit light of different colors when displaying different subfield images; and
the control circuit is connected to the array substrate and the backlight module.

It should be understood that both the foregoing general description and the following detailed description are exemplary and explanatory only and are not construed as limiting the present disclosure.

### BRIEF DESCRIPTION OF DRAWINGS

The accompanying drawings, which are incorporated into and constitute a part of the specification, illustrate embodiments consistent with the present disclosure and are used in conjunction with the specification to explain the principles of the present disclosure. Apparently, the accompanying drawings in the following description illustrate merely some embodiments of the present disclosure, and those of ordinary skill in the art may still derive other accompanying drawings from these accompanying drawings without creative efforts.

FIG. 1 is a schematic structural diagram of a liquid crystal display apparatus according to some embodiments of the present disclosure;

FIG. 2 is a schematic circuit diagram of a liquid crystal display apparatus according to some embodiments of the present disclosure;

FIG. 3 is a local schematic diagram of an m-th frame of image of a liquid crystal display apparatus in a first operating mode according to the present disclosure;

FIGS. 4 to 6 are schematic principle diagrams of three subfield images of the m-th frame of image shown in FIG. 3.

FIG. 7 is a schematic diagram of an electronic device according to some embodiments of the present disclosure;

FIG. 8 is a schematic diagram illustrating initial color information in a YUV color space in a liquid crystal display apparatus according to the present disclosure;

FIG. 9 is a schematic diagram illustrating a relationship between a conversion angle and an initial hue angle in a first liquid crystal display apparatus according to the present disclosure;

FIG. 10 is a schematic diagram illustrating a relationship between a reduction coefficient and an initial hue angle in a second liquid crystal display apparatus according to the present disclosure; and

FIG. 11 is a diagram illustrating a corresponding relationship between an adjustment coefficient and initial luminance in a third liquid crystal display apparatus according to the present disclosure.

### DETAILED DESCRIPTION

Exemplary embodiments will now be described more comprehensively with reference to the accompanying drawings. However, the exemplary embodiments may be implemented in various forms, and should not be understood as being limited to the embodiments described herein. On the contrary, these embodiments are provided to make the present disclosure comprehensive and complete, and comprehensively convey the idea of the exemplary embodiments to a person skilled in the art. The same reference numerals in the accompanying drawings indicate the same or similar structures, and thus, a detailed description thereof will be omitted. In addition, the accompanying drawings are only schematic illustrations of the present disclosure and are not necessarily drawn to scale.

The terms “one,” “a,” “the,” “said,” and “at least one” are used to indicate the presence of one or more elements/components/etc.; the terms “include,” “comprise,” and “provided with” are used to indicate open-ended inclusion and mean that additional elements/components/etc. may be present in addition to the listed elements/components/etc.; the terms “first,” “second,” “third,” or the like are used merely as labels, and are not intended to limit the number of objects thereof.

Existing liquid crystal display panels have high light loss and high energy consumption during light emission.

It should be noted that the information disclosed in the above Background section is only used for the enhancement of understanding of the background of the present disclosure and, therefore, may include information that does not constitute the prior art known to those of ordinary skill in the art.

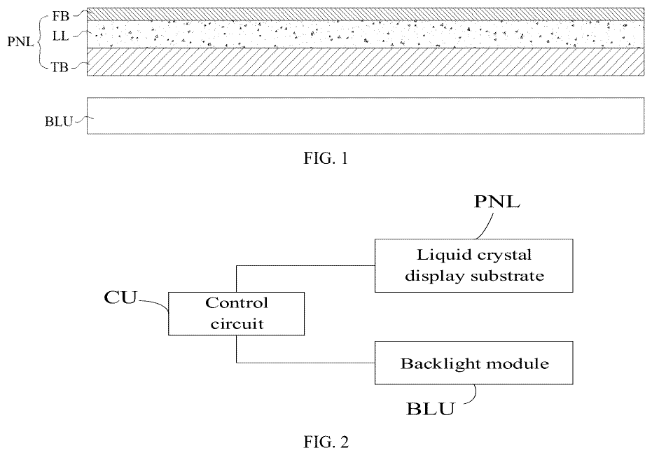

A liquid crystal display apparatus is provided according to the embodiments of the present disclosure. As shown in FIGS. 1 and 2, the liquid crystal display apparatus includes a liquid crystal display panel PNL and a control circuit CU.

The liquid crystal display panel PNL is provided with a plurality of arrayed pixels, and each pixel is the smallest light-emitting unit. The liquid crystal display panel PNL includes an array substrate TB and an opposing substrate FB that are opposite to each other, and a liquid crystal layer LL disposed between the array substrate TB and the opposing substrate FB.

The liquid crystal display panel PNL further includes a pixel electrode and a common electrode. The pixel electrode is disposed on the array substrate TB, and the common electrode is disposed on either the array substrate TB or the opposing substrate FB. Moreover, a pixel includes a pixel electrode. The array substrate TB is provided with a driver circuit. The control circuit CU is disposed on the array substrate TB, and controls the voltage between the pixel electrode and the common electrode via the driver circuit to control the deflection degree of the liquid crystal molecules in the liquid crystal layer LL and further control the light transmittance of each pixel, such that the gray level of each pixel is adjusted.

The liquid crystal display apparatus further includes a backlight module BLU disposed on a side, distal from the opposing substrate FB, of the array substrate TB. The backlight module BLU emits light toward the array substrate TB under the control of the control circuit CU.

In some embodiments, the opposing substrate FB includes a color film layer. The color film layer includes a plurality of filter parts, and a pixel including a filter part. Through the filtering effect of the filter part, a pixel emits monochromatic light, and different pixels emit light of different colors. However, the color film layer causes considerable loss of light, and the luminance of the liquid crystal display apparatus is reduced in a case where the power of the backlight module BLU is not improved. However, the power of the backlight module BLU needs to be increased to increase the luminance, which leads to increased power consumption.

For improvement of the light output efficiency without increasing power consumption, in some embodiments, a color film layer is not disposed on the opposing substrate FB to reduce light loss, which is beneficial for improving the light output efficiency. The backlight module BLU includes light-emitting components of n different colors to achieve color display, and the number of light-emitting components of the same color is not specifically limited herein and may be one or more. The color of light emitted by the backlight module BLU is the hue that forms an image. Based on this, field-sequential display may be used in displaying an image. For example, n subfield images are sequentially displayed within one frame period, and each of the subfield images is a monochrome image. In each subfield image, different pixels have different gray levels, and the gray level of the same pixel varies across different subfield images. The backlight module BLU emits light of the same color when displaying the same subfield image, and emits light of different colors when displaying different subfield images. For example, in displaying each subfield image, only light-emitting components of a color in the backlight module BLU emits light, such that each subfield image has only a hue, i.e., a color. Therefore, based on the phenomenon of visual persistence, a frame of image is acquired.

As shown in FIG. 2, in some embodiments of the present disclosure, the control circuit CU is configured to perform one or more operating modes, including a first operating mode. In the first operating mode:

the control circuit CU is configured to: receive initial color information of each pixel of an m-th frame of image, and control, based on the initial color information, the liquid crystal display panel PNL to sequentially display subfield images of n different hues, such that the m-th frame of image is acquired. m and n are positive integers, and n≥2.

The initial color information of each pixel may include initial gray levels under n hues. For a pixel of a frame of image, temporal color-mixing is achieved by sequentially displaying the gray levels of n hues, such that the pixel presents a predetermined color. For example, in the case where n=3, and the three hues are red, green, and blue, the initial color information of each pixel in the m-th frame of image includes an initial gray level of red, an initial gray level of green, and an initial gray level of blue.

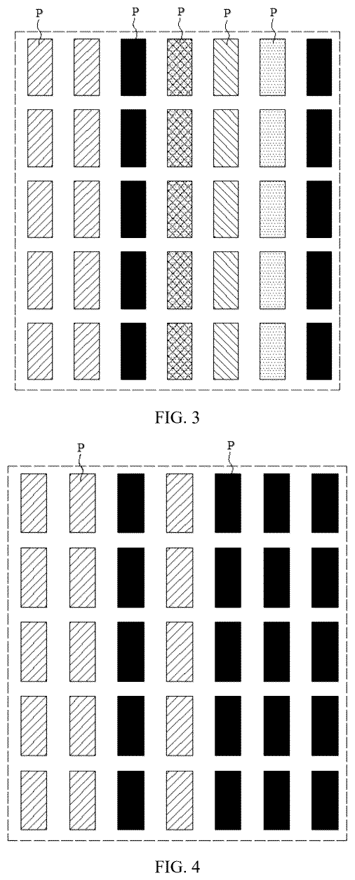

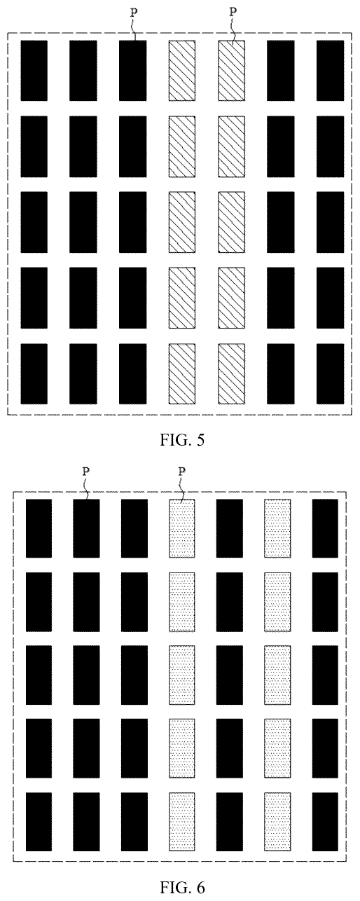

FIGS. 4 to 6 illustrate three subfield images. In different subfield images, the emitting pixels P form a plurality of stripe patterns, and the emitting pixels in different subfield images may be different and may also the same. That is, the same pixel may emit light in each subfield image. The three subfield images form the m-th frame of image shown in FIG. 3. It should be noted that FIG. 3 is merely used to schematically illustrate the color-mixing of the three subfield images and the resulting visual effect, and does not limit the specific pattern of the subfield images.

In some embodiments, the backlight module BLU includes three types of light-emitting components, which respectively emit red light, green light, and blue light. A frame of image is divided into three subfield images, and the hues of the patterns of the three subfield images are red, green, and blue, respectively. The three subfield images are displayed sequentially to visually form a frame of image.

As shown in FIG. 2, the control circuit CU is connected to the array substrate TB and the backlight module BLU to control the light emission of the backlight module BLU and the deflection degree of the liquid crystal, that is, controlling the color and gray level of each pixel. The control circuit CU includes a timing controller, a gate driver circuit, a source driver circuit, a backlight control circuit, and the like, and the configuration thereof is not particularly limited herein.

The inventor has discovered that, in the case of adopting field-sequential display, since a frame of image needs to be composed of color-mixing from several subfield images that are displayed at different times, red, green, and blue hues may be simultaneously observed in the image when users blink or saccade or a target in the image moves. That is, color separation phenomenon may occur.

The inventor has discovered multiple factors affecting color separation through researches, and the color separation phenomenon may be mitigated based on the factors. Exemplary explanations are provided hereinafter.

### First Liquid Crystal Display Apparatus According to the Present Disclosure

In a first operating mode, the control circuit CU processes the initial color information of at least part of the pixels of the m-th frame of image to acquire actual color information of the pixels. The actual color information of each pixel includes actual gray levels under n hues, and the actual gray level corresponds to the initial gray level of the same hue. Meanwhile, n field-sequential images are generated based on the actual gray levels in the actual color information, each field-sequential image has the same hue, and hues of different field-sequential images are different, such that the m-th frame of image is acquired.

In the m-th frame of image, pixels for which initial gray levels are processed are defined as target pixels. Upon processing, the color reflected by the actual color information of the target pixels is different from the color reflected by the initial color information, and the difference between the actual gray levels of the same target pixel is greater than the difference between the initial gray levels of the same target pixel.

For a target pixel, the difference in initial gray levels and the difference in actual gray levels are represented by differences among different hues. For example, in the case where n=3, and the hues of both the initial gray levels and the actual gray levels are red (R), green (G), and blue (B), the difference in initial gray levels is represented by calculating a difference between maximum and the minimum among the initial gray levels, or an average value of differences between each pair of the initial gray levels, or a difference between two closest initial gray levels. Furthermore, for example, the initial gray levels of one piece of initial color information are (R=255, G=255, B=255), and the initial gray levels of another piece of initial color information are (R=255, G=10, B=10). The difference in gray levels of (R=255, G=10, B=10) is greater than that of (R=255, G=255, B=255). The representation of the difference in actual gray levels is the same as that of the difference in initial gray levels, which will not be described in detail here.

In some embodiments of the present disclosure, the initial color information is converted from the RGB color space to the YUV color space, and the initial color information is transformed within the YUV space to acquire the actual color information. After re-conversion of the actual color information to the RGB color space, the field-sequential image is displayed based on the actual gray levels. A detailed explanation is provided hereinafter.

The initial color information of the target pixel is converted from the RGB space to the YUV space using the following formula:

$$[ \begin{matrix}Y \\ U \\ V\end{matrix} ] = [ \begin{matrix}{y}_{R} & {y}_{G} & {y}_{B} \\ {b}_{R} & {b}_{G} & {b}_{B} \\ {r}_{R} & {r}_{G} & {r}_{B}\end{matrix} ] [ \begin{matrix}R \\ G \\ B\end{matrix} ] .$$

$$[ \begin{matrix}{y}_{R} & {y}_{G} & {y}_{B} \\ {b}_{R} & {b}_{G} & {b}_{B} \\ {r}_{R} & {r}_{G} & {r}_{B}\end{matrix} ]$$

represents a conversion matrix. R, G, and B represent the initial color information of the target pixel in the RGB color space, and Y, U, and V represent the initial color information in the YUV color space, and Y represents the initial luminance of the target sub-pixel. The specific conversion principle will not be described in detail here.

As shown in FIG. 8, in the YUV color space, the hue angle of the color reflected by the initial color information is defined as the initial hue angle θs, and the hue angle of the color reflected by the actual color information is defined as the actual hue angle. Meanwhile, in the YUV space, hue angles of n reference colors are reference hue angles, and n reference axes passing through the origin are used to represent the reference colors. Meanwhile, a plurality of auxiliary colors different from the reference colors are selected, and the auxiliary colors are represented by auxiliary axes passing through the origin, such that the YUV color space is divided into a plurality of areas based on the auxiliary colors and the reference colors.

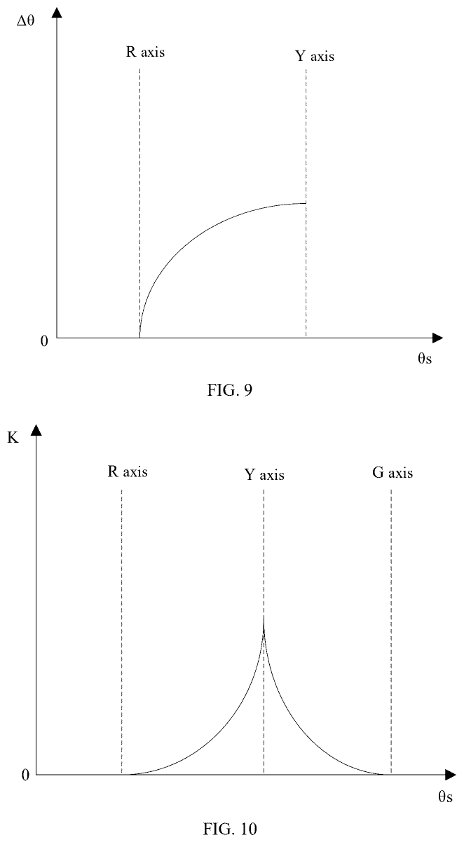

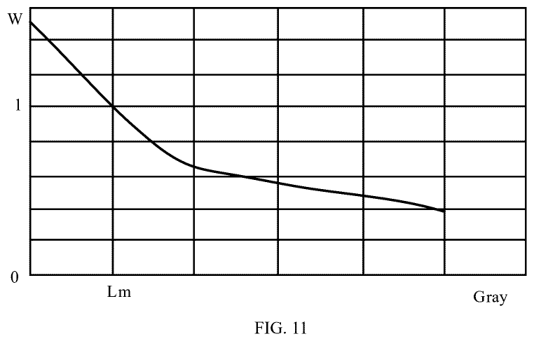

For example, as shown in FIG. 9, n is 3, and the reference colors are red, green, and blue. The three reference axes represent red (R axis), green (G axis), and blue (B axis), respectively. Three auxiliary colors are defined, that is, magenta (M axis), yellow (Y axis), and cyan (C axis), respectively. The three reference axes and the three auxiliary axes are used to divide the YUV color space into six areas. Meanwhile, in the YUV space, the horizontal axis is the U axis, and the vertical axis is the V axis, which are different from the reference and auxiliary axes described above.

Furthermore, in the YUV color space, the initial color information and the actual color information of the same target pixel satisfy:

$$[ \begin{matrix}{U}_{t}^{′} \\ {V}_{t}^{′}\end{matrix} ] = [ \begin{matrix}sin Δθ & cos Δ θ \\ cos Δ θ & - sin Δ θ\end{matrix} ] \cdot [ \begin{matrix}{U}_{t} \\ {V}_{t}\end{matrix} ] .$$

Uₜ and Vₜ represent the coordinates of the color reflected by the initial color information, and Uₜ′ and Vₜ′ represent the coordinates of the color reflected by the actual color information, Δθ represents the conversion angle which is the difference between the initial hue angle θs and the actual hue angle.

In the YUV color space, upon acquisition of initial color information of the target pixel and conversion of the initial color information to the YUV color space, the reference axis closest to the initial hue angle θs of the color reflected by the initial color information is determined, and the actual hue angle is acquired by rotating the initial hue angle θs by an angle toward the closest reference axis. The angle is the conversion angle Δθ. Compared with the initial hue angle θs, the actual hue angle is closer to the reference hue angle; that is, the difference between the color in the initial color information and the reference color is reduced to acquire the actual color information.

The difference between the initial hue angle θs and the reference hue angle closest to the initial hue angle is defined as the initial angle, and the difference between the reference hue angle closest to the initial hue angle θs and the actual hue angle is defined as the actual angle. For the same target pixel, the initial angle is greater than the actual angle. The initial angle is positively correlated with the conversion angle Δθ. That is, in a case where the initial angle is larger, the conversion angle Δθ is larger, i.e., the magnitude of approaching the reference axis is great. In other words, a case where initial angles are different, conversion angles Δθ are different, and the differences between the initial gray levels and the actual gray levels are also different. Since the color of the reference axis has the greatest difference in gray levels, such a method may increase the difference between gray levels, and actual gray levels with greater differences replace the initial gray levels.

For increment of the smoothness of the actual gray level and avoiding the impact on the image quality caused by the abrupt change, the conversion angle and the initial hue angle θs satisfy:
as shown in FIG. 9, in the YUV color space, in the case where the initial hue angle θs falls between the hue angle of red (R axis) and the hue angle of yellow (Y axis), between the hue angle of green (G axis) and the hue angle of cyan (C axis), or between the hue angle of blue (B axis) and the hue angle of magenta (M axis), the conversion angle Δθ is positively correlated with the initial hue angle θs; or
in the case where the initial hue angle θs falls between the hue angle of magenta and the hue angle of red, between the hue angle of yellow and the hue angle of green, or between the hue angle of cyan and the hue angle of blue, the conversion angle Δ0 is negatively correlated with the initial hue angle θs.

In FIG. 9, θs represents a schematic representation of the initial hue angle and does not specifically limit the angle thereof, that is, the hue angle is an angle between a ray that passes through a point reflecting a color and the origin and the U axis.

For example, as shown in FIG. 9, between two adjacent reference axes, the initial hue angle θs and the conversion angle Δθ satisfy:

Δ0=a0s²+bθs+c.

a, b, and c represent constants, and a is a negative number.

In some other embodiments of the present disclosure, between two adjacent reference axes, the initial hue angle θs and the conversion angle Δθ have a linear relationship or another gradual relationship, as long as the relationship conforms to the positive and negative correlation described above.

The target pixels may be part or all of the plurality of pixels. For example, in the case where the color reflected by the initial color information of each pixel does not fall on the reference axis, all pixels are target pixels and are converted from initial gray levels to actual gray levels as described above. In the case where the color reflected by the initial color information of part of the pixels falls on the reference axis, for example, in the YUV space, and the initial color information of part of the pixels determines the color to be red, green, or blue, the initial gray levels of the part of pixels are the actual gray levels and are not converted. In displaying the m-th frame of image, the initial gray level is directly used for display.

In addition, in the m-th frame of image, in the case where the color reflected by the initial color information of part of the pixels falls on the auxiliary axis, a conversion rule is preset. For example, the initial hue angle θs is set by default to rotate by a rotation angle toward the reference axis in either the clockwise or counterclockwise direction to acquire the actual hue angle.

Based on the first liquid crystal display apparatus, a method for displaying an image is described hereinafter.

The method for displaying the image includes: performing S110 to S130 in a first operating mode.

In S110, initial color information of each pixel of an m-th frame of image is received, wherein the initial color information of each pixel includes initial gray levels under n different hues; m and n are positive integers, and n≥2.

In S120, actual color information of the pixels is determined based on the initial color information, wherein the actual color information of each pixel includes actual gray levels under the n hues; and at least part of the pixels are target pixels, wherein the color reflected by the actual color information of the target pixel is different from that reflected by the initial color information, and the difference among the actual gray levels of the same target pixel is greater than that among the initial gray levels.

In some embodiments of the present disclosure, determining the actual color information of the pixels based on the initial color information, namely S120, includes S1210 to S1240.

In S1210, the initial gray levels are set in the YUV color space, wherein in the YUV color space, the hue angle of the color reflected by the initial color information is the initial hue angle θs; and the hue angles of n reference colors are the reference hue angles.

In S1220, in the YUV color space, a reference hue angle closest to the initial hue angle θs is determined, wherein a difference between the initial hue angle θs and the reference hue angle closest to the initial hue angle is an initial angle.

In S1230, an actual hue angle is determined based on the initial angle, wherein a difference between the reference hue angle closest to the initial hue angle θs and the actual hue angle is an actual angle, and the initial angle is greater than the actual angle.

The initial hue angle θs is rotated by an angle (rotation angle) toward the closest reference axis to acquire the actual hue angle.

In S1240, actual color information is determined based on the color reflected by the actual hue angle.

In S130, the liquid crystal display panel is controlled, based on the actual color information, to sequentially display subfield images of n hues, such that the m-th frame of image is acquired.

The details of the method for displaying the image have been described in detail in the above embodiments of the first liquid crystal display apparatus, which will not be repeated here.

### Second Liquid Crystal Display Apparatus

In the first operating mode, the control circuit processes the initial color information of at least part of the pixels of the m-th frame of image to acquire actual color information of the pixels. The actual color information of each pixel includes actual gray levels under n hues, and the actual gray level corresponds to the initial gray level of the same hue. Meanwhile, n field-sequential images are generated based on the actual gray levels in the actual color information, each field-sequential image has the same hue, and hues of different field-sequential images are different, such that the m-th frame of image is acquired.

In the m-th frame of image, pixels for which initial gray levels are processed are defined as target pixels. Upon processing, the luminance of the color reflected by the actual color information of the same target pixel is less than the luminance of the color reflected by the initial color information of the same target pixel. A ratio of the initial gray level in the initial color information to the actual gray level of the same hue in the actual color information is a reduction coefficient K. The reduction coefficient K is less than 1 and greater than 0. The initial gray level is reduced through the reduction coefficient K to acquire the actual gray level. Meanwhile, since each initial gray level is multiplied by the same reduction coefficient K to acquire the actual gray level, the color reflected by the initial color information is the same as the color reflected by the actual color information, with only the luminance being reduced.

In some embodiments of the present disclosure, different reduction coefficients K are used for different initial color information to acquire the actual color information. For example, the initial color information is converted from the RGB color space to the YUV color space. For the specific conversion method, reference may be made to the description of the conversion between the RGB color space and the YUV color space in the first liquid crystal display apparatus, which will not be described in detail here.

In the YUV color space, the hue angle of the color reflected by the initial color information is the initial hue angle θs, and the hue angle of the color reflected by the actual color information is the actual hue angle. The hue angles of n reference colors are the reference hue angles. The difference between the initial hue angle θs and the reference hue angle closest to the initial hue angle is the initial angle. The reduction coefficient K is selected based on the size of the initial angle. For the same target pixel, the initial angle is negatively correlated with the reduction coefficient K. That is, in a case where the initial angle is larger, the reduction coefficient K is larger; in other words, in a case where the distance between the initial angle and the reference axis is great, the reduction coefficient K is larger.

Based on the second liquid crystal display apparatus, a method for displaying an image is described hereinafter.

The method for displaying the image includes: performing S210 to S230 in a first operating mode.

In S210, initial color information of each pixel of an m-th frame of image is received, wherein the initial color information of each pixel includes initial gray levels under n different hues, m and n are positive integers, and n≥2.

In S220, actual color information of the pixels is determined based on the initial color information, wherein the actual color information of each pixel includes actual gray levels under n hues; and at least part of the pixels are target pixels, wherein, the actual gray level of the same target pixel of the same hue is less than the initial gray level thereof.

Determining the actual color information of the pixels based on the initial color information, namely S220, may include the following processes.

In S2210, the initial gray levels are set in the YUV color space, wherein in the YUV color space, the hue angle of the color reflected by the initial color information is the initial hue angle θs; and the hue angles of n reference colors are the reference hue angles.

In S2220, a reduction coefficient K is determined based on the initial hue angle θs and a reference hue angle closest to the initial hue angle.

In S2230, actual gray levels of the pixels are determined based on the initial gray levels of at least part of the pixels and the reduction coefficient K, wherein the reduction coefficient K is the ratio of the initial gray level to the actual gray level of the same hue of the same target pixel.

In S230, the liquid crystal display panel is controlled, based on the actual color information, to sequentially display subfield images of n hues, such that the m-th frame of image is acquired.

For increment of the smoothness of the actual gray level and avoiding the impact on the image quality caused by the abrupt change, the reduction coefficient K and the initial hue angle θs satisfy:
as shown in FIG. 8, in the YUV color space, in the case where the initial hue angle θs falls between the red hue angle and the yellow hue angle, between the green hue angle and the cyan hue angle, or between the blue hue angle and the magenta hue angle, the reduction coefficient K is positively correlated with the initial hue angle θs; or
in the case where the initial hue angle θs falls between the hue angle of magenta and the hue angle of red, between the hue angle of yellow and the hue angle of green, or between the hue angle of cyan and the hue angle of blue, the reduction coefficient K is negatively correlated with the initial hue angle θs.

For example, as shown in FIG. 10, between two adjacent reference axes, the initial hue angle θs and the reduction coefficient K satisfy:

K=a0s²+bθs+c.

a, b, and c represent constants, and a is a positive number.

In some other embodiments of the present disclosure, between two adjacent reference axes, the initial hue angle θs and the reduction coefficient K have a linear relationship or another gradual relationship, as long as the relationship conforms to the positive and negative correlation described above.

The target pixels may be part or all of the plurality of pixels. For example, in the case where the color reflected by the initial color information of each pixel does not fall on the reference axis, all pixels are target pixels and are converted from initial gray levels to actual gray levels as described above. In the case where the color reflected by the initial color information of part of the pixels falls on the reference axis, for example, in the YUV space, and the initial color information of part of the pixels determines the color to be red, green, or blue, the initial gray levels of the part of pixels are the actual gray levels and are not converted. In displaying the m-th frame of image, the initial gray level is directly used for display.

In addition, in the m-th frame of image, in the case where the color reflected by the initial color information of part of the pixels falls on the auxiliary axis, the reduction coefficient is a maximum value.

### Third Liquid Crystal Display Apparatus

In the first operating mode, the control circuit processes the initial color information of at least part of the pixels of the m-th frame of image to acquire actual color information of the pixels. The actual color information of each pixel includes actual gray levels under n hues, and the actual gray level corresponds to the initial gray level of the same hue. Meanwhile, n field-sequential images are generated based on the actual gray levels in the actual color information, each field-sequential image has the same hue, and hues of different field-sequential images are different, such that the m-th frame of image is acquired.

In the m-th frame of image, a luminance threshold serves as a basis for comparison. In the case where the luminance of the color reflected by the initial color information is initial luminance Gray, the luminance is high when the initial luminance Gray is greater than the luminance threshold Lm; and the luminance is low when the initial luminance Gray is less than the luminance threshold Lm. Based on this, pixels with initial luminance Gray different from the luminance threshold Lm are defined as target pixels, and the target pixels include a first target pixel and a second target pixel. The first target pixel is a pixel with initial luminance Gray lower than the luminance threshold Lm, and the second target pixel is a pixel with initial luminance Gray greater than the luminance threshold Lm.

For the same first target pixel at the same hue, the actual gray level is less than the initial gray level. That is, for a target pixel with higher luminance, the luminance of the target pixel is reduced so that the actual gray level is less than the initial gray level. Meanwhile, for the same second target pixel at the same hue, the actual gray level is greater than the initial gray level. That is, for a target pixel with lower luminance, the luminance of the target pixel is increased so that the actual gray level is greater than the initial gray level. Therefore, the contrast of at least part of the pixels in the m-th frame of image is reduced, thereby mitigating the color separation phenomenon.

In some embodiments of the present disclosure, the initial color information is converted from the RGB color space to the YUV color space. For the specific conversion method, reference may be made to the description of the conversion between the RGB color space and the YUV color space in the first liquid crystal display apparatus, which will not be described in detail here.

In the YUV color space, a first adjustment coefficient and a second adjustment coefficient are determined based on the initial color information of the first target pixel and the second target pixel and the relationship between the preset initial luminance Gray and the adjustment coefficient W, the actual color information is acquired by multiplying the first adjustment coefficient by Y, U, and V that reflect the initial color information and is then converted to the RGB color space, such that the ratio of the color reflected by the actual color information of the first target pixel to the color reflected by the initial color information of the first target pixel is the first adjustment coefficient, and the ratio of the luminance reflecting the actual color information of the first target pixel to the luminance reflecting the initial color information of the first target pixel is the first adjustment coefficient. Similarly, the actual color information is acquired by multiplying the second adjustment coefficient by Y, U, and V that reflect the initial color information, such that the ratio of the luminance reflecting the actual color information of the second target pixel to the luminance reflecting the initial color information of the first target pixel is the second adjustment coefficient. The ratio of the luminance reflecting the actual color information of the second target pixel to the luminance reflecting the initial color information of the second target pixel is the second adjustment coefficient.

The initial luminance Gray is calculated by the following formula:

Gray=(k1×R+k2×G+k3×B).

R, G, and B represent the gray levels of red, green, and blue respectively, k1 is 0.3, k2 is 0.59, and k3 is 0.11. k1, k2, and k3 may also take other values.

The adjustment coefficient W is negatively correlated with the initial luminance Gray. That is, in a case where the initial luminance Gray is smaller, the adjustment coefficient W is smaller. The corresponding relationship between the initial luminance Gray and the adjustment coefficient W may be determined based on empirical data, experimental data, and the like, which is not specifically limited herein.

The second adjustment coefficient may be greater than the first adjustment coefficient, the first adjustment coefficient is less than 1 and greater than 0, and the second adjustment coefficient is greater than 1.

Based on the above third liquid crystal display apparatus, a method for displaying an image is described hereinafter.

The method for displaying the image may include: performing S310 to S330 in a first operating mode.

In S310, initial color information of each pixel of an m-th frame of image is received, where the initial color information of each pixel includes initial gray levels under n different hues, m and n are positive integers, and n≥2.

In S320, a first adjustment coefficient and a second adjustment coefficient are determined based on initial luminance of each pixel reflected by the initial color information of each pixel and a corresponding relationship between preset luminance and an adjustment coefficient, wherein the second adjustment coefficient is greater than the first adjustment coefficient, the first adjustment coefficient is greater than 0 and less than 1, and the second adjustment coefficient is greater than 1.

In S330, an actual gray level with respect to an initial gray level of a first pixel, whose initial luminance is greater than a luminance threshold, is determined based on the first adjustment coefficient; an actual gray level with respect to an initial gray level of a second pixel, whose luminance is less than the luminance threshold, is determined based on the second adjustment coefficient; and actual color information of the pixel is acquired, such that the actual gray level of the first pixel is less than the initial gray level thereof, and the actual gray level of the second pixel is greater than the initial gray level thereof.

In the YUV color space, the actual color information of the first pixel is acquired by multiplying both the part of coordinates of a color reflecting the initial color information and the initial luminance by the first adjustment coefficient, and the actual color information of the pixel is acquired by multiplying both the part of coordinates of a color reflecting the initial color information and the initial luminance by the second adjustment coefficient.

In S340, the liquid crystal display panel is controlled, based on the actual color information, to sequentially display subfield images of n hues, such that the m-th frame of image is acquired.

In some embodiments of the present disclosure, one, two, or all three of the solutions for mitigating the color separation phenomenon in the three types of liquid crystal display panels may exist simultaneously.

In addition, in some embodiments of the present disclosure, the control circuit CU further has a second operating mode, and is configured, in the second operating mode, to: control, in receiving initial color information of an m-th frame of image, the liquid crystal display apparatus to sequentially display n subfield images, such that the m-th frame of image is acquired. m and n are positive integers, and n is greater than or equal to 2. The actual color information of each pixel is the initial color information thereof, and the actual gray level is the initial gray level thereof.

In the second operating mode, the initial gray level is directly used as the actual gray level for display, without performing the processing of the initial gray level as carried out in the first operating mode.

The first operating mode and the second operating mode may be activated upon receiving an activation signal. For example, an image acquisition apparatus is used to acquire an image of the eyeball of the user, and an image processing apparatus is used to determine a movement speed of the eyeball based on the image of the eyeball. Moreover, in the case where the movement speed reaches a speed threshold, the color separation phenomenon becomes noticeable. In this case, the control circuit CU is set to be in the first operating mode to eliminate color separation. In the case where the movement speed does not reach the speed threshold, the color separation phenomenon is not noticeable. In this case, the control circuit CU is set to be in the second operating mode to improve the operational efficiency.

The embodiments of the present disclosure further provide an electronic device, which includes a liquid crystal display apparatus. The structure of the liquid crystal display apparatus may be the liquid crystal display apparatus according to any of the embodiments described above, which will not be repeated here.

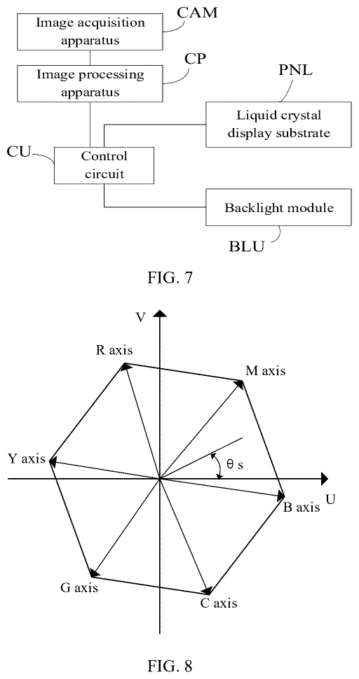

As shown in FIG. 7, the electronic device further includes an image acquisition apparatus and an image processing apparatus.

The image acquisition apparatus CAM may include one or more cameras. Other apparatuses capable of acquiring image information, such as human body or object feature information, may also be used. Images of the eyeball of the user may be acquired in real time using the image acquisition apparatus CAM.

The image processing apparatus CP is connected to the image acquisition apparatus CAM, and determines the movement speed of the eyeball based on the image of the eyeball. Moreover, in the case where the movement speed reaches a speed threshold, the image processing apparatus outputs an activation signal to the control circuit CU to control the control circuit CU to enter the first operating mode. In the case where the movement speed does not reach the speed threshold, the image processing apparatus does not output the activation signal to control the control circuit CU to be in the second operating mode.

The image processing apparatus CP identifies a pupil center based on the image of the eyeball, and determines the movement speed of the eyeball based on the change in the position of the pupil center.

In some embodiments, the electronic device further includes an infrared detection apparatus, which positions a corneal center of the user by infrared light. A line connecting the corneal center and the pupil center identified by the image processing apparatus is an optical axis of a visual system. An actual gaze direction is then acquired based on an angle between the optical axis and a visual axis. In addition, the electronic device further includes a heat mirror to reduce a tracking error without affecting image display or to transmit infrared light and eye images using an optical waveguide.

In addition, other means may also be used to realize eye tracking, which are not specifically limited herein.

The electronic device according to the present disclosure may be a mobile phone, a television, a tablet computer, or a head-mounted display device, such as smart glasses, which will not be listed one by one here.

It should be noted that, although the processes of the method for displaying the image in the present disclosure are described in a specific order in the accompanying drawings, this is not required or implied to mean that the processes must be performed in the specific order, or that all the illustrated processes must be performed to achieve the desired result. Additionally or alternatively, some processes may be omitted, a plurality of processes may be combined into one process for execution, and/or one process may be divided into a plurality of processes for execution, among other variations.

According to the liquid crystal display apparatus, the method for displaying the image, and the electronic device of the present disclosure, field-sequential display may be achieved through temporal color-mixing, rather than using spatial color-mixing, of n sequentially-displayed subfield images, such that the color films are not required, the light output efficiency is improved, the sub-pixels of different colors are not required, and the resolution is improved. Meanwhile, at least one of the following advantageous effects is achieved.
1. In the first operating mode, for a pixel, the actual gray level is acquired by increasing the difference among the initial gray levels of the pixel, and then the subfield image is displayed based on the actual gray levels. Compared to directly display of the subfield image based on the initial gray level, increment of the difference among the actual gray levels allows the color of the pixel in the m-th frame of image to be closer to the white point, such that the color separation phenomenon is mitigated.
2. In the first operating mode, the actual gray level is acquired by reducing the initial gray level of the same hue of the same target pixel, and then the subfield image is displayed based on the actual gray level. Compared to directly display of the subfield image based on the initial gray level, reduction of the gray level may decrease the luminance of the pixel in the m-th frame of image, and the decrease in luminance may make the color separation more unnoticeable, such that the color separation phenomenon is mitigated.
3. In the first operating mode, the first adjustment coefficient and the second adjustment coefficient are respectively determined based on initial luminance determined based on the initial color information and the relationship between a preset luminance and an adjustment coefficient. The first adjustment coefficient is greater than 0 and less than 1, and the second adjustment coefficient is greater than 1. Meanwhile, the first adjustment coefficient is used to reduce the initial gray level of pixels whose initial luminance is greater than the luminance threshold, thereby acquiring the actual gray level of the pixels; the second adjustment coefficient is used to increase the initial gray level of pixels whose initial luminance is less than the luminance threshold, thereby acquiring the actual gray level of the pixels. As a result, the luminance of pixels with higher initial luminance decreases, and the luminance of pixels with lower initial luminance increases, such that the difference in luminance is reduced, that is, the contrast is reduced, which makes the color separation more unnoticeable, thereby mitigating the color separation phenomenon.

Other embodiments of the present disclosure are apparent to those skilled in the art from consideration of the specification and practice of the present disclosure disclosed herein. The present disclosure is intended to cover any variations, uses, or adaptations of the present disclosure following the general principles of the present disclosure and including known common knowledge or customary technical means undisclosed in the art of the present disclosure. The specification and embodiments are only considered as exemplary, and the true scope and spirit of the present disclosure are indicated in the appended claims.

1. A liquid crystal display apparatus, comprising: a liquid crystal display panel and a control circuit, wherein the liquid crystal display panel comprises a plurality of pixels;
the control circuit has a first operating mode, and is configured, in the first operating mode, to: receive initial color information of each of the plurality of pixels of an m-th frame of image, and control, based on the initial color information, the liquid crystal display panel to sequentially display subfield images of n different hues, such that the m-th frame of image is acquired, wherein m and n are positive integers, n≥2, and the initial color information of each of the plurality of pixels comprises initial gray levels under the n hues; and
in the m-th frame of image, actual color information of each of the plurality of pixels comprises actual gray levels under the n hues; and at least part of the plurality of pixels are target pixels, wherein a color reflected by the actual color information of each of the target pixels is different from a color reflected by the initial color information, and a difference among the actual gray levels of a same target pixel is greater than a difference among the initial gray levels of the same target pixel.

2. The liquid crystal display apparatus according to claim 1, wherein
in a YUV color space, a hue angle of the color reflected by the initial color information is an initial hue angle, and a hue angle of the color reflected by the actual color information is an actual hue angle; and hue angles of n reference colors are reference hue angles; and
in the YUV color space, a difference between the initial hue angle and a reference hue angle closest to the initial hue angle is an initial angle; a difference between the reference hue angle closest to the initial hue angle and the actual hue angle is an actual angle; the initial angle of the same target pixel is greater than the actual angle.

3. The liquid crystal display apparatus according to claim 2, wherein in the YUV color space, the initial hue angle and the actual hue angle of the same target pixel satisfy:
$$[ \begin{matrix}{U}_{t}^{′} \\ {V}_{t}^{′}\end{matrix} ] = [ \begin{matrix}sin Δθ & cos Δ θ \\ cos Δ θ & - sin Δ θ\end{matrix} ] \cdot [ \begin{matrix}{U}_{t} \\ {V}_{t}\end{matrix} ] ;$$
wherein Uₜ and Vₜ represent coordinates of the color reflected by the initial color information, and Uₜ′ and Vₜ′ represent coordinates of the color reflected by the actual color information, and Δθ represents a conversion angle, the conversion angle being a difference between the initial hue angle and the actual hue angle.

4. The liquid crystal display apparatus according to claim 3, wherein the initial angle is positively correlated with the conversion angle.

5. A liquid crystal display apparatus, comprising: a liquid crystal display panel and a control circuit, wherein the liquid crystal display panel comprises a plurality of pixels;
the control circuit has a first operating mode, and is configured, in the first operating mode, to: receive initial color information of each of the plurality of pixels of an m-th frame of image, and control, based on the initial color information, the liquid crystal display panel to sequentially display subfield images of n different hues, such that the m-th frame of image is acquired, wherein m and n are positive integers, n≥2, and the initial color information of each of the plurality of pixels comprises initial gray levels under the n hues; and
in the m-th frame of image, actual color information of each of the plurality of pixels comprises actual gray levels under the n hues; and at least part of the plurality of pixels are target pixels, wherein luminance of a color reflected by the actual color information of a same target pixel is less than luminance of a color reflected by the initial color information of the same target pixel.

6. The liquid crystal display apparatus according to claim 5, wherein
in a YUV color space, a hue angle of the color reflected by the initial color information is an initial hue angle, and a hue angle of the color reflected by the actual color information is an actual hue angle; hue angles of n reference colors are reference hue angles; and for a same hue of the same target pixel, a ratio of the initial gray level to the actual gray level is a reduction coefficient; and
in the YUV color space, a difference between the initial hue angle and a reference hue angle closest to the initial hue angle is an initial angle, and the initial angle of the same target pixel is positively correlated with the reduction coefficient.

7. A liquid crystal display apparatus, comprising: a liquid crystal display panel and a control circuit, wherein the liquid crystal display panel comprises a plurality of pixels;
the control circuit has a first operating mode, and is configured, in the first operating mode, to: receive initial color information of each of the plurality of pixels of an m-th frame of image, and control, based on the initial color information, the liquid crystal display panel to sequentially display subfield images of n different hues, such that the m-th frame of image is acquired, wherein m and n are positive integers, n≥2, and the initial color information of each of the plurality of pixels comprises initial gray levels under the n hues; and
in the m-th frame of image, actual color information of each of the plurality of pixels comprises actual gray levels under the n hues; and at least part of the pixels are target pixels, wherein the target pixels comprise a first target pixel and a second target pixel; luminance reflecting the initial color information of the first target pixel is greater than a luminance threshold, and luminance reflecting the initial color information of the second target pixel is less than the luminance threshold; for a same hue of a same first target pixel, the actual gray level is less than the initial gray level, and for a same hue of a same second target pixel, the actual gray level is greater than the initial gray level.

8. The liquid crystal display apparatus according to claim 7, wherein in a YUV color space, a ratio of a color reflected by the actual color information of the first target pixel to coordinates reflecting the initial color information of the first target pixel is a first adjustment coefficient, and a ratio of luminance reflecting the actual color information of the second target pixel to the luminance reflecting the initial color information of the first target pixel is the first adjustment coefficient; and
a ratio of a color reflected by the actual color information of the second target pixel to coordinates reflecting the initial color information of the second target pixel is a second adjustment coefficient, and a ratio of the luminance reflecting the actual color information of the second target pixel to the luminance reflecting the initial color information of the second target pixel is the second adjustment coefficient;
wherein the second adjustment coefficient is greater than the first adjustment coefficient.

9. The liquid crystal display apparatus according to claim 8, wherein both the first adjustment coefficient and the second adjustment coefficient are negatively correlated with luminance reflecting the actual color information of the target pixel.

10. The liquid crystal display apparatus according to claim 1, wherein the control circuit further has a second operating mode, and is configured, in the second operating mode, to: control, in receiving the initial color information of the m-th frame of image, the liquid crystal display apparatus to sequentially display n subfield images, such that the m-th frame of image is acquired, wherein in the second operating mode, the actual gray level of each of the plurality of pixels is the initial gray level of the each of the plurality of pixels.

11. The liquid crystal display apparatus according to claim 1, wherein
the liquid crystal display panel comprises: an array substrate and an opposing substrate that are opposite to each other; and a liquid crystal layer disposed between the array substrate and the opposing substrate;
the liquid crystal display apparatus further comprises: a backlight module disposed on a side, distal from the opposing substrate, of the array substrate and comprising light-emitting components of n different colors, wherein the backlight module emits light of a same color when displaying a same subfield image and emit light of different colors when displaying different subfield images; and
the control circuit is connected to the array substrate and the backlight module.

12-18. (canceled)

19. The liquid crystal display apparatus according to claim 1, wherein the actual color information of each of the plurality of pixels is determined based on the initial color information of the each of the plurality of pixels, and the control circuit is configured, in the first operating mode, to control, based on the actual color information, the liquid crystal display panel to sequentially display subfield images of the n hues, such that the m-th frame of image is acquired.

20. The liquid crystal display apparatus according to claim 5, wherein the actual color information of each of the plurality of pixels is determined based on the initial color information of the each of the plurality of pixels, and the control circuit is configured, in the first operating mode, to control, based on the actual color information, the liquid crystal display panel to sequentially display subfield images of the n hues, such that the m-th frame of image is acquired.

21. The liquid crystal display apparatus according to claim 5, wherein the control circuit further has a second operating mode, and is configured, in the second operating mode, to: control, in receiving the initial color information of the m-th frame of image, the liquid crystal display apparatus to sequentially display n subfield images, such that the m-th frame of image is acquired, wherein in the second operating mode, the actual gray level of each of the plurality of pixels is the initial gray level of the each of the plurality of pixels.

22. The liquid crystal display apparatus according to claim 5, wherein the liquid crystal display panel comprises: an array substrate and an opposing substrate that are opposite to each other; and a liquid crystal layer disposed between the array substrate and the opposing substrate;
the liquid crystal display apparatus further comprises: a backlight module disposed on a side, distal from the opposing substrate, of the array substrate and comprising light-emitting components of n different colors, wherein the backlight module emits light of a same color when displaying a same subfield image and emit light of different colors when displaying different subfield images; and
the control circuit is connected to the array substrate and the backlight module.

23. The liquid crystal display apparatus according to claim 8, wherein the first adjustment coefficient is greater than 0 and less than 1, and the second adjustment coefficient is greater than 1; and the control circuit is configured, in the first operating mode, to control, based on the actual color information, the liquid crystal display panel to sequentially display subfield images of the n hues, such that the m-th frame of image is acquired.

24. The liquid crystal display apparatus according to claim 7, wherein the control circuit further has a second operating mode, and is configured, in the second operating mode, to: control, in receiving the initial color information of the m-th frame of image, the liquid crystal display apparatus to sequentially display n subfield images, such that the m-th frame of image is acquired, wherein in the second operating mode, the actual gray level of each of the plurality of pixels is the initial gray level of the each of the plurality of pixels.

25. The liquid crystal display apparatus according to claim 7, wherein the liquid crystal display panel comprises: an array substrate and an opposing substrate that are opposite to each other; and a liquid crystal layer disposed between the array substrate and the opposing substrate;
the liquid crystal display apparatus further comprises: a backlight module disposed on a side, distal from the opposing substrate, of the array substrate and comprising light-emitting components of n different colors, wherein the backlight module emits light of a same color when displaying a same subfield image and emit light of different colors when displaying different subfield images; and
the control circuit is connected to the array substrate and the backlight module.
